(19) United States
(12) Patent Application Publication
(10) Pub. No.: US 2019/0192953 A1
(43) Pub. Date: Jun. 27, 2019

(54) PORTABLE SCOREKEEPING DEVICE

(71) Applicant: Dimple H. Thakkar, Los Angeles, CA (US)

(72) Inventor: Dimple H. Thakkar, Los Angeles, CA (US)

(21) Appl. No.: 15/850,484

(22) Filed: Dec. 21, 2017

(51) Int. Cl. A63B 71/06; G09B 19/00

(52) U.S. Cl. CPC A63B 71/0669; G09B 19/0092; A63B 2209/00; A63B 2210/50; A63B 69/38; A63B 2220/808; A63B 2207/02; A63B 2220/806; A63B 2225/50

(57) ABSTRACT

Apparatus, method and system of portable scorekeeping device including a scoreboard device, a smart wristband device, and a scoreboard device functioning with a smart wristband device. The scoreboard device comprising at least one display region including low resolution light emitting diode light emitters of different colors and a frame containing the at least one display region, wherein the scoreboard device is formed of at least one soft material to enable folding of the at least one display region of the scoreboard device without using a joint. The scoreboard device wirelessly and communicatively connects with a wristband device which controls displaying, updating and storing the scores of one of the sports freely selected or customized by a user.

### TECHNICAL FIELD

This disclosure relates generally to an apparatus, method and system of portable scorekeeping, including a scoreboard display, a smart wristband, and a system including the scoreboard in communication with the smart wristband.

### BACKGROUND OF THE DISCLOSURE

Scoreboards are used to display the scores of sports games. Conventional scoreboards that display scores for the players or audience during sports games tend to be permanent structures made of rigid materials. The conventional scoreboard is therefore heavy, cumbersome, and not practical for players to transport to a practice or a game. Once the scoreboard is set up, often the player is required to keep track of scores, which detracts the player's focus from his/her athletic performance. Therefore, there is a demand for a portable scorekeeping device that may help users/players/spectators keep track of a score during competitive/recreational sports, leagues, or games or display other performance data at-a-glance for enhancing athletic performance.

### SUMMARY

The examples of the present disclosure that are described herein below include devices, systems, and methods for a scoreboard device for keeping track of and displaying scores of sports, comprising at least one display region including a plurality of light emitting diodes of different colors and a frame containing the at least one display, wherein the scoreboard device may be formed of at least one sheet of soft material to enable folding or collapsing of a portion of the scoreboard, and the at least one soft material includes a fabric material.

In another exemplary embodiment of the present disclosure, the scoreboard device may be folded to have a book-cover shape and may be capable of being hung on a net or fence. The scoreboard device may be folded to have opposite outer surfaces displaying scores of a selected sport, and both of the opposite outer surfaces may display either the same image or different images.

In another exemplary embodiment of the present disclosure, the scoreboard device may wirelessly connect to and communicate with a wristband device that controls the functions of displaying, updating and storing the scores of a sport freely selected or customized by a user.

In another exemplary embodiment of the present disclosure, the scoreboard device may further comprise a voice control device for voice-controlling the scoreboard device to display, update and store the scores of a sport freely selected or customized by a user.

In another exemplary embodiment of the present disclosure, the scoreboard device may further comprise one or more buttons for button-controlling the scoreboard device to display, update and store the scores of a sport freely selected or customized by a user.

In another exemplary embodiment of the present disclosure, the scoreboard device may further comprise a camera mounted on, or in wireless communication with, the scoreboard device to detect and track the movement of a ball so as to update the scores or performance parameters, such as ball speed, of a sport freely selected or customized by a user.

Another exemplary embodiment of the present disclosure may include a wristband device for keeping track of and displaying the scores of sports, comprising a controller that includes a processor configured to update the scores, display the scores, and store the scores in a memory device in response to voice or button controls activated by a user.

In another exemplary embodiment of the present disclosure, the wristband device may further comprise a camera mounted on, or in wireless communication with, the wristband device to detect and track a movement of a ball.

In another exemplary embodiment of the present disclosure, the wristband device may be capable of installing applications downloaded from a network that may be used to calculate scores, which may include any corresponding game and/or player data, export the scores, calculate nutritional information related to a sport, provide shopping information, and post names of players available for practice.

One or more embodiments of the present disclosure may include a system for keeping track of and displaying scores, comprising a scoreboard device having at least one display region, including light emitting diodes of different light colors, and a frame containing the at least one display region, wherein the scoreboard device is formed of at least one soft material to enable folding of the at least one display region of the scoreboard device without using a joint, and a wristband device having a controller that includes a processor configured to update the scores, display the scores, and store the scores in a memory device, wherein the wristband device wirelessly connects to and communicates with the scoreboard device.

Another embodiment of the present disclosure may include a method for keeping track of and displaying scores, comprising the steps of controlling a scoreboard device with a wristband device wirelessly connected to and in communication with the scoreboard device, wherein the wristband device comprises a controller that includes a processor configured to update the scores, display the scores, and store the scores in a memory device. The method further comprises comparing the scores and displaying a winner and loser of a game. The method further comprises determining and displaying nutritional information for the winner and the loser of the game, and determining and displaying postings related to trainers and players for practice, based on the scores. The method may further comprise playing back a video about a scoring moment and changing the updated scores.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 illustrates an exemplary embodiment of the scoreboard device of the present disclosure.

FIG. 2 illustrates another exemplary embodiment of the scoreboard device of the present disclosure folded in a book-cover shape.

FIG. 3 illustrates another exemplary embodiment of the scoreboard device of the present disclosure hung on a sports net.

FIG. 4 illustrates another exemplary embodiment of the scoreboard device of the present disclosure connected to a computer.

FIG. 5 illustrates another exemplary embodiment of the scoreboard device of the present disclosure wirelessly connected to and in communication with a mobile device.

FIG. 6 illustrates an exemplary embodiment of the wireless communication between the scoreboard device of the present disclosure and a mobile device.

FIG. 7 illustrates another exemplary embodiment of the scoreboard device of the present disclosure wirelessly connected to a wristband device.

FIG. 8 illustrates another exemplary embodiment of the smart wristband device of the present disclosure.

FIG. 9 illustrates another exemplary embodiment of the smart wristband device of the present disclosure.

FIG. 10 illustrates another exemplary embodiment of the smart wristband device of the present disclosure.

FIG. 11 illustrates a customized screen displayed in a display region of a scoreboard or wristband device of one or more exemplary embodiments of the present disclosure.

FIG. 12 illustrates a customized screen displayed in a scoreboard or wristband device of one or more exemplary embodiments of the present disclosure.

FIG. 13 illustrates a customized screen displayed in a scoreboard or wristband device of one or more exemplary embodiments of the present disclosure.

FIG. 14 illustrates a customized screen displayed in a scoreboard or wristband device of one or more exemplary embodiments of the present disclosure.

FIG. 15 illustrates a system of one or more exemplary embodiments of the present disclosure including a scoreboard device and a smart wristband device.

FIG. 16 is a flowchart illustrating a method of one or more exemplary embodiments of the present disclosure.

FIG. 17 illustrates a scoreboard device of one or more exemplary embodiments of the present disclosure including a camera.

### DETAILED DESCRIPTION

It is to be understood that the following disclosure provides many different embodiments, or examples, for implementing different features of the invention. Specific embodiments, details, or examples of components and arrangements are described below to simplify the present disclosure. These are, of course, merely examples and are not intended to be limiting. For example, dimensions of elements are not limited to the disclosed range or values, but may depend upon process conditions and/or desired properties of the device. It should be apparent to those skilled in the art that the present teachings may be practiced without such details. In other instances, well-known methods, procedures, components, and/or circuitry have been described at a relatively high-level, without detail, in order to avoid unnecessarily obscuring aspects of the present teachings. In addition, various features may be arbitrarily drawn in different scales for simplicity and clarity.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation, in addition to the orientation depicted in the figures. The device may be otherwise oriented (rotated 90 degrees or at other orientations), and the spatially relative descriptors used herein may likewise be interpreted accordingly. In addition, the term “made of” may mean either “comprising” or “consisting of.”

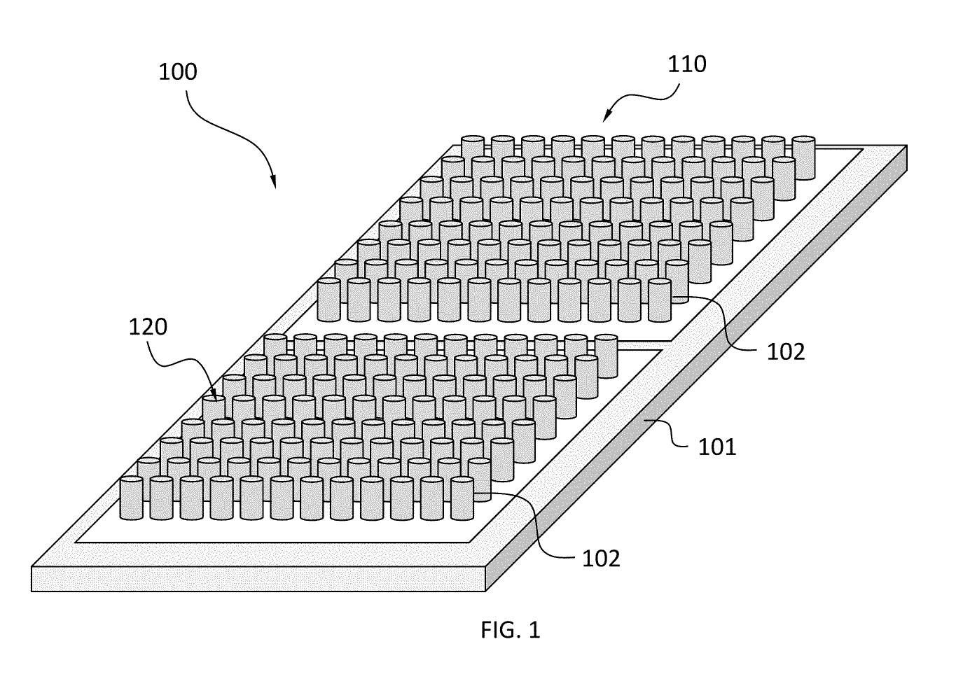

FIG. 1 illustrates a portable scoreboard device 100 of an embodiment of the present disclosure having a matrix 101 of light emitting diodes (LEDs) 102 of different light colors and a frame 101 having a first display region 110 and a second display region 120. The display regions 110 and 120 have LEDs 102. The LEDs 102 may be surface-mounted LEDs or wire-bonded LEDs separated from each other and having separate encapsulation made of epoxy resin, etc. In another embodiment, the LEDs 102 may be entirely formed of thin films by a thin film deposition method, for example, pulsed laser deposition, sputtering, or e-beam epitaxy or chemical vapor deposition. The display regions 110 and 120 may comprise LEDs arranged in a low resolution arrangement, for example having a uniform density 6 LEDs per inch (36 LEDs per square inch) or similar or finer densities. In said low resolution arrangement, the LEDs may be organized in one or more matrices or modules. One or more matrices or modules may be electrically connected to form a larger matrix of LEDs such that the display regions 110 and 120 display a single, uninterrupted image. In alternative embodiments, the display regions 110 and 120 may comprise other lighting sources, such as modules containing incandescent, fluorescent, or high-intensity discharge bulbs.

In FIG. 1, each of the display regions 110 and 120 of the scoreboard device 100 is installed with an array of LEDs 102, and the array may take the form of lines, a matrix, or any predetermined or changeable shape or pattern.

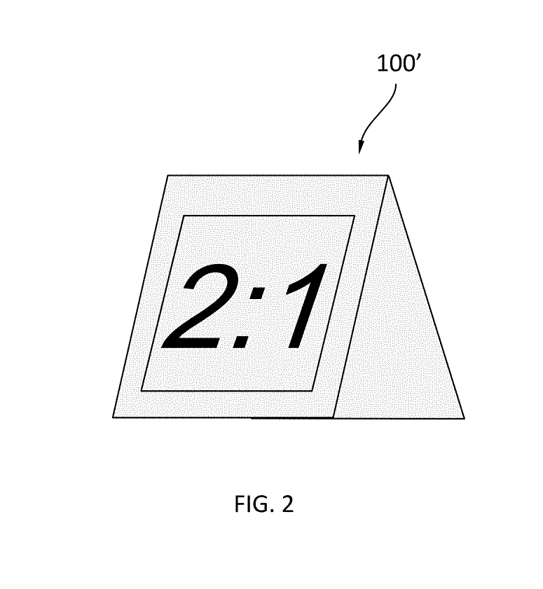

The portable scoreboard device 100 may be formed of at least one soft material, such as a fabric material, so that the scoreboard device 100 and each of the display regions 110 and 120 may be folded without using a joint. The scoreboard device 100 may be folded in a book-cover shape (FIG. 2), tube-shape (not-shown), box-shape (not shown), or any other shape that may effectively display information to all the players. Additionally the scoreboard device 100 may be folded in any of the aforementioned shapes to cover an item having a shape other than a sports net. The displayed images in the display regions 110 and 120 may also be re-oriented for the users/players to correctly view the images displayed in the display regions 110 and 120 of the folded scoreboard device 100.

In some embodiments, the portable scoreboard device 100 of the present disclosure has weatherproof qualities. For example, a transparent film, coating or cover may be secured over the matrix 101 of LEDs 102 or over the entire scoreboard device 100 to create a weatherproof result. This weatherproofing may allow the portable scoreboard device 100 to withstand the potentially harsh conditions of outdoor use, which depending on the climate, could include moisture, wind, rain, dust, debris, varying ranges of temperature, etc. It is to be understood that any material, coating, or method for weatherproofing electronic devices known to those skilled in the art may be used in conjunction with the scoreboard device 100 of the present disclosure. Similarly, the portable scoreboard device 100 of the present disclosure may comprise materials that allow it to be folded as described above, but also protect the display regions 110 and 120 from incidental contact from players, balls, or other sports equipment that could cause damage. Such materials could comprise the same materials that aid in weatherproofing the portable scoreboard device 100, or may comprise other materials that provide protection without compromising the aforementioned functions.

FIG. 2 illustrates an embodiment of the scoreboard device 100′ folded in a book-cover shape. In FIG. 2, the folded scoreboard device 100′ in the book-cover shape may have display regions 110 and 120 located at opposite outer surfaces, and each of the display regions 110 and 120 may display the same or different images, depending on a user's requirements. For example, while being used at practice or during competition, the display regions 110 and 120 may display the same image with a correct orientation to be viewed by the players at both sides of the scoreboard device 100′ so that players on both sides may simultaneously view the same scores. In other instances, such as during sports that require one or more players to be grouped at only one side of a sport field (e.g., squash or bowling), one of display regions 110 and 120 may display an updating score, and the other one of the display regions 110 and 120 may display a notice, such as “Do Not Disturb” or an advertisement of a sponsor company of the player or team. In other words, the display regions 110 and 120 of the scoreboard device are capable of displaying different content.

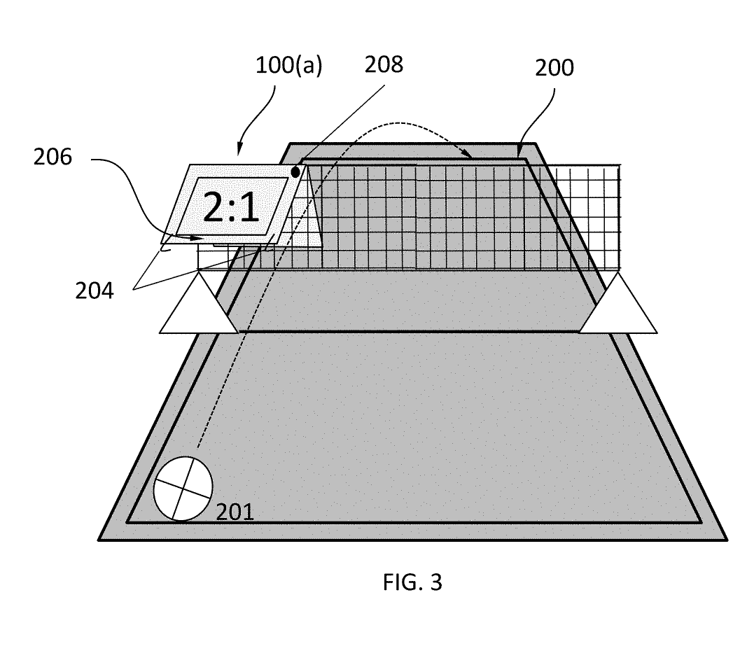

FIG. 3 illustrates that the portable scoreboard device 100(a), when folded in a book-shape, may be hung on a sports net 200, (e.g., a tennis net) so as to display real-time scores to the players at both sides of the net 200. Players on both sides of the sports net 200 may simultaneously maintain concentration on the tennis ball 201 (or game generally) and view the updating scores on the portable scoreboard device 100(a) without compromising their game-stance or concentration as they otherwise would for a conventional scoreboard facing only a lateral side. In this embodiment, the scoreboard device 100(a) may also include fastening hooks 204 which may be used to attach the lower portions 206 of the device 100(a) to the sport net 200 to ensure that the device 100(a) is retained in position on the net. Additionally, the device 100(a) may include anti-theft features, such as a locking mechanism 208, that can secure the device 100(a) to a structure to reduce the chance of theft. The locking mechanism 208 may attach to fastening hooks 204 or may attach to another portion of the device 100(a). The locking mechanism 208 may include tracking means, such as GPS, that allows a user to track the device 100(a) using an application on a mobile device in the event the device 100(a) is lost or stolen.

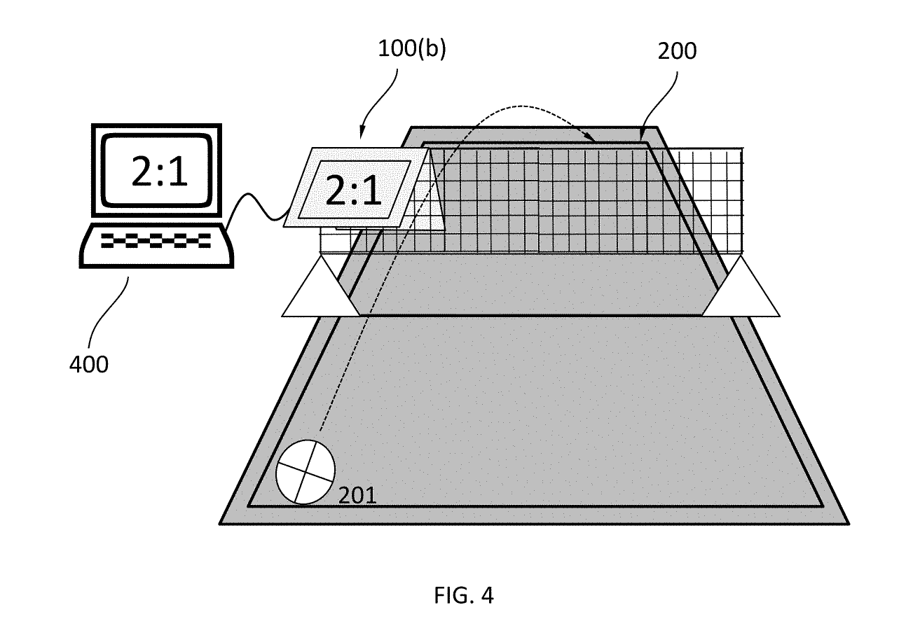

FIG. 4 illustrates an embodiment of the scoreboard device 100(b) of the present disclosure connected to a portable computer 400. The scoreboard device 100(b) may be controlled by the computer 400, which is connected wirelessly or by cable to the scoreboard device 100(b). If the scoreboard is connected wirelessly, the computer 400 may communicate with the scoreboard device 100(b) using one or more of a variety of technologies, including short-range Bluetooth, ultra-wideband, ZigBee, and Wi-Fi, and telecommunication networks using 3G, 4G (LTE), or 5G data. The computer 400 may be operated under various operation systems/platforms, including Windows, for example. The computer 400 may provide a user with an interface to update/change the scores of a sport or display selected or customized messages on the scoreboard device 100(b). The source of the displayed information may be obtained through server connectivity to the computer 400 via the Internet or other network-attached systems.

The computer 400 may include a processor, memory, communications and display interfaces, and various other components that work together to customize the display format, for example, based on a user's choice of font, font color, or font size. Also, the computer 400 may store the scores of a game in a memory device of the computer 400 having volatile and/or nonvolatile memory capacity for future use. The computer 400 may install new display formats to the scoreboard device 100(b) based on new rules of different sports, or update the display formats that may be used to display scores of different sports with updated rules of games.

As an alternative embodiment to any of the various embodiments herein, the computer 400 may be internal to the scoreboard device 100(b) itself, which would then include a processor, memory, and various other components necessary to implement the display and receive information external to the scoreboard 100(c).

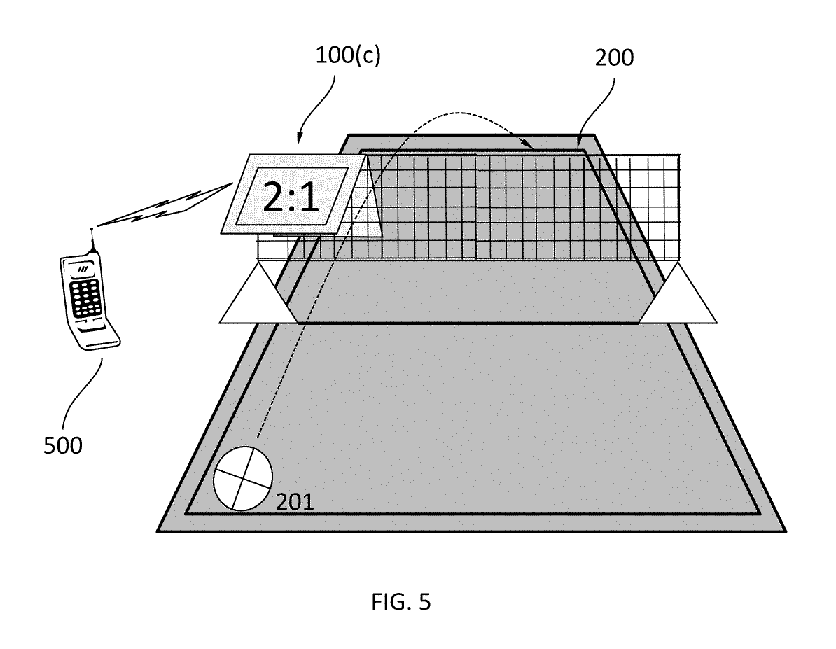

FIG. 5 illustrates an embodiment of the scoreboard device 100(c) of the present disclosure, wherein the scoreboard device 100(c) may be in wireless communication with a mobile device 500, such as a mobile phone or smartphone, using any operating system, for example, Android, Windows Mobile, BlackBerry, or iOS. In some embodiments, the scoreboard device 100(c) communicates with the mobile device 500 through one or more of a short-range communication mode such as Bluetooth, ultra-wideband, ZigBee, Wi-Fi, and telecommunication networks using 3G, 4G (LTE), or 5G data.

The mobile device 500 may customize the display format of the device 100(c). For example a user may operate the mobile device 500 to customize the font, font color, font size, number of lines displayed, and screen size, etc. Also, the mobile device 500 may store the scores of a game in a memory of the mobile device 500 for future use. The mobile device 500 may install score display formats based on the requirements of various games to the scoreboard device 100(c) to update the display and score. For example, baseball scores may be displayed in a multi-inning format, allowing the display at various times to display strikes/hits/outs, and at other times to display the runs for each team. Using the mobile device 500, the display may additionally be altered to show tennis score formats. Also, updated game rules, players and various other changes may be instantly updated to the device 100(c).

The mobile device 500 may send emergency messages such as weather warnings, evacuation notices or other alerts to the scoreboard device to notify the players of conditions that may affect the sport and/or the safety of the players. Also, the mobile device 500 may send device calls to the scoreboard device 100(c) so that the user/player may be immediately aware of device calls even if the mobile device 500 is not on the user/player's person or if the mobile device 500 is in silent mode. The incoming message may be indicated using a blinking light partially or entirely displayed in the display regions 110 and/or 120 of scoreboard device 100(c) to get the attention of the user(s)/player(s) and to let all the players viewing the scoreboard device 100(c) know that a pause of the game may be required.

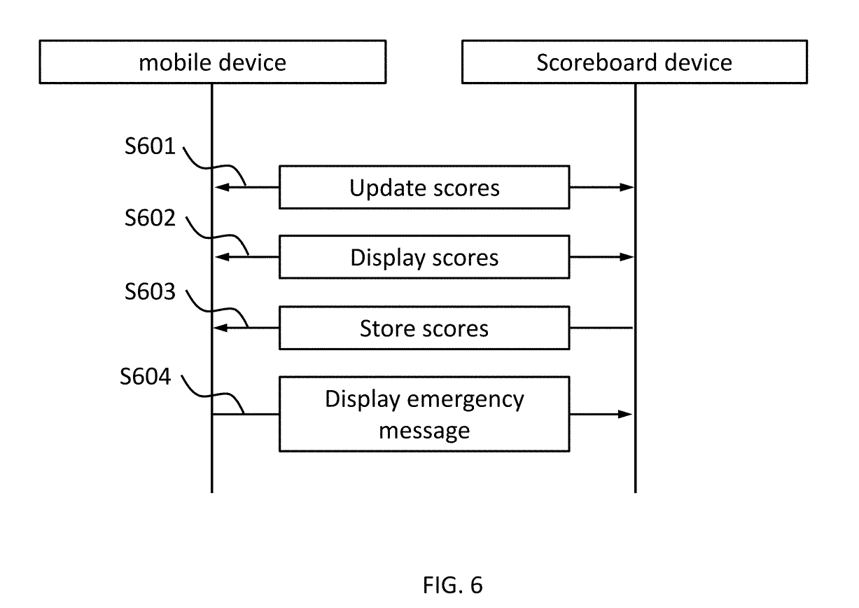

FIG. 6 illustrates an exemplary embodiment of the wireless communication between the scoreboard device and a mobile device. The communication may comprise a mobile device sending a signal to a scoreboard device, requesting to update scores S601, which the scoreboard device accepts and processes. The scoreboard device may also communicate with the mobile device to display the score(s) of a game S602. Also, in S603, the scoreboard device may send signals to the mobile device to store the score. In S604, the mobile device may send a signal to the scoreboard device to display an emergency message, for example, if inclement weather is incoming.

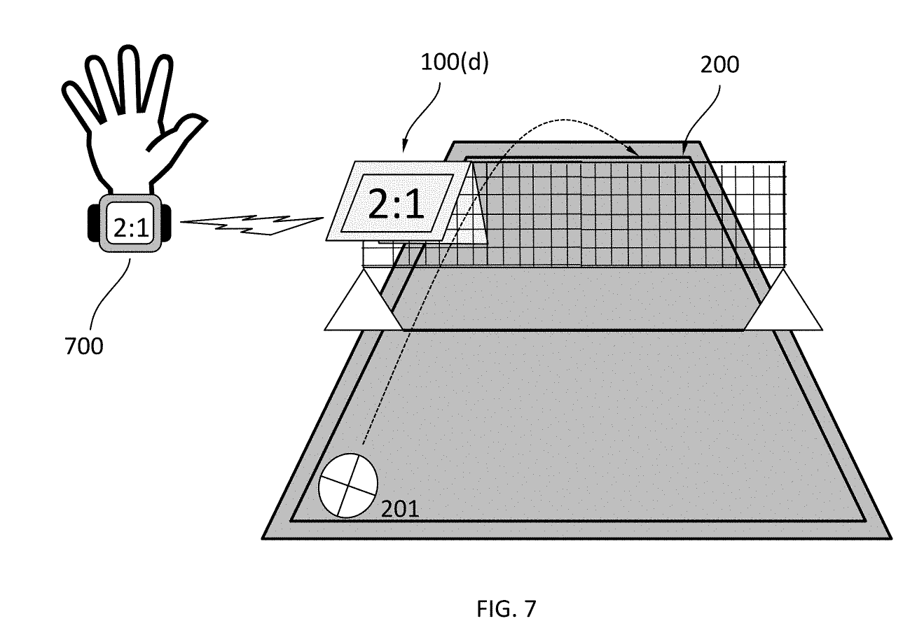

FIG. 7 illustrates an embodiment of the scoreboard device 100(d) of the present disclosure, wherein the scoreboard device 100(d) may wirelessly communicate with a wristband device 700 using communicates with the mobile device 500 through one or more of a short-range communication mode such as Bluetooth, ultra-wideband, ZigBee, Wi-Fi, and telecommunication networks using 3G, 4G (LTE), or 5G data. In some embodiments, the wristband device 700 could be an Apple Watch, Samsung Gear, Moto 360, or any other smartwatch or wearable smart-device. The wristband device 700 may also be capable of running applications configured to interact with the scoreboard device 100(d). In some embodiments, the wristband device 700 may wirelessly communicate directly with the scoreboard device 100(d) via any one or more communication technologies disclosed above. In other embodiments, the wristband device 700 may wirelessly connect to a mobile device, such as a smartphone, which in turn is connected to the scoreboard device 100(d), either wirelessly or through a wired connection.

Users may easily set up the scoreboard device 100(d) for various sports activities, for example, a tennis match. The scoreboard device 100(d) is updated by one or more players wearing the smart wristband device 700 via Bluetooth or any wireless communicative connection methods or means. Similarly, users may easily set-up the portable scoreboard device 100(d) for a different sport, such as a soccer match, and the scores displayed by the scoreboard device 100(d) are updated by a designated scorekeeper (such as a judge or a team captain), who wears the smart wristband 700 to control the updates displayed on the scoreboard device 100(d). In another embodiment, for a baseball pitcher who wants to practice his/her pitch speed, he/she may bring the scoreboard device 100(d) to the field, throw pitches, and watch the scoreboard device 100(d) update with the speed of each pitch. In another exemplary embodiment, for a runner who wants to test his/her speed on the running track, the runner may use the smart wristband device's 700 display and/or scoreboard device's 100(d) display region 110 and/or 120 to display real-time speed and/or time data. Also, the runner may program the scoreboard device 100(d) to help keep and set goals. For example, the scoreboard device 100(d) may emit and audio signal, such as a “beep,” when a selected goal or other parameter is met. Further, all running times or other related data may be archived and stored in the wirelessly-connected smartphone, which may be configured to install and execute a special application to share said stored data with coaches, friends, and/or family who also have the same application downloaded on their own devices.

The scoreboard device 100(d), and the wristband device 700, alone or in combination, may function to allow recreational players of any sport to update the scoreboard device 100(d) via a wristband device 700 worn by at least one player. Data may be archived on the scoreboard device 100(d) and synchronized with a smartphone application for more optional features, such as score analyses and comparisons of scores for selected players. Also, the scoreboard device 100(d), alone or in combination with the wristband device 700, may store player performance data (e.g., forehand speed, backhand speed, longest rally, etc.) via a smartphone application. Also, the devices may provide a practice mode that allows players to use the scoreboard device 100(d) and/or wristband device 700 as a visual guide to help improve their skills.

The scoreboard device of the present disclosure, comprising opposite, two-sided screens, may adapt and display any type of scoreboard for any type of sport. Additionally, the scoreboard device in exemplary embodiments may be capable of transmitting and receiving data from one or more wristband devices, smartphones, or a combination of the two using any wireless means. In some embodiments of the present disclosure, the portable scoreboard device and/or the wristband device (“scoreboard/wristband device”) may be waterproof, weatherproof, solar-powered, piezoelectric or motion powered, wave powered, body heat powered, and may be rechargeable, portable, and lightweight. The scoreboard/wristband device of the present disclosure may include optional features, such as connection via Wi-Fi or hotspot for real-time data transfer or other data transfer options, and may be connected to a mobile carrier (T-Mobile, Sprint, etc.).

In some embodiments, the scoreboard/wristband device may be voice-enabled (e.g., via Alexa, Siri, etc.). For example, the user may use voice commands to control the scoreboard/wristband device to update a score or other parameter, whereby said score or other parameter is automatically updated on the scoreboard/wristband device.

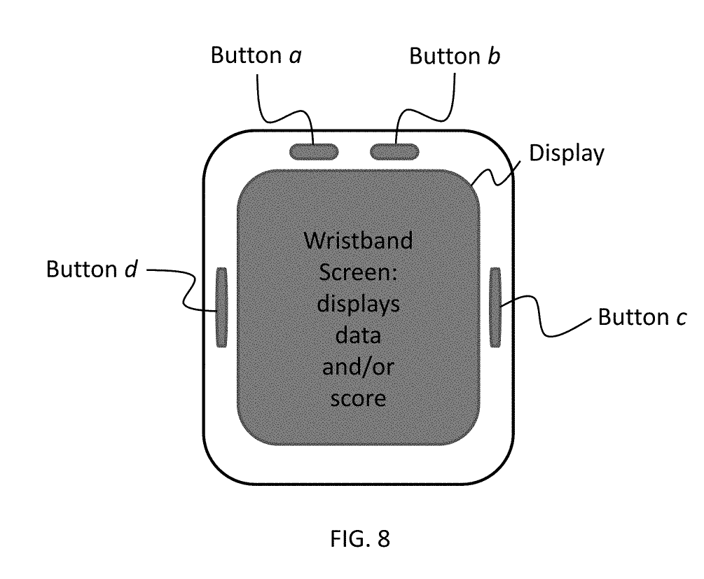

Also, the scoreboard/wristband device may include buttons for button-controlling the scoreboard/wristband device. The buttons (i.e., buttons a, b, c, and din FIGS. 8 through 10) include a button to update score of a home team/player, a button to update the score of a visitor team/player, a button to undo the update of a score, and a button to change a display mode for a selected or customized view of information, such as pitch speed, etc. Buttons may also be combined to perform more than one function. For example, in some embodiments of the present disclosure, different buttons may have different functions based on the time duration of touch. For example, a short-duration touch corresponds to button a, and a long-duration touch corresponds to button c. In this way, all functions may be eventually performed by only one button. Also, a person of ordinary skill in the art would appreciate that the scoreboard/wristband device may include more or less than four buttons, and each button may correspond to one or more of a variety of functions. For example, there may be a button for weather forecast, a button for email, a button for contacting emergency service in case of an injury, etc.

The scoreboard/wristband device may include a music playing device, such as a CD player or an MP3 player, and/or may include applications that can synchronize with music streaming services, including but not limited to Pandora, Spotify and Amazon Music. Further, the scoreboard/wristband device may comprise built-in speakers to play music selected by the user of the scoreboard/wristband device. Such functionality would allow the user to play music during sporting activities. Additionally, the music could be used to correspond with various functions of the scoreboard/wristband device. For example, a setting on the scoreboard/wristband device could allow music to play when the scoreboard/wristband device updates a score. Also, the music playing device may play a specific song when a certain score is reached so as to encourage the player to achieve a certain score. When a game is finished, the music playing device may play a user-selected or pre-programmed song to indicate an end of a game. One of ordinary skill in the art would appreciate any method for selecting and playing music via a music playing device of the scoreboard/wristband device of the present disclosure.

The scoreboard/wristband device allows the user to adjust time parameters by the hour, minute, and second, and to start/stop/pause a timer. The scoreboard/wristband device of the present disclosure may also enable a buzzer feature to indicate a score, time period, and/or to signal the end of game, such as is common in basketball and hockey. The scoreboard/wristband device may optionally turn on sounds (e.g., beeps) to alert someone that a score has been changed so as to prevent cheating or accidental score change. The wristband device and the scoreboard device may simultaneously mirror scores from each other. The scoreboard/wristband device may also provide sounds of beeps when it is time to change sides, change serves, etc., and may also provide cheat-proof technology to avoid unwanted score-changes. However, the scoreboard/wristband may also allow manual changes to scores to account for accidental changes.

Regarding device applications, the user of the scoreboard/wristband device may download mobile applications to one or more devices including a smartphone and the portable scoreboard and wristband devices of the present disclosure to allow players to log/archive their scores with opponents, add/allow people such as friends to view leaderboards or auto-coaching, have access to niche marketplaces, and log other data (fitness & nutrition), etc.

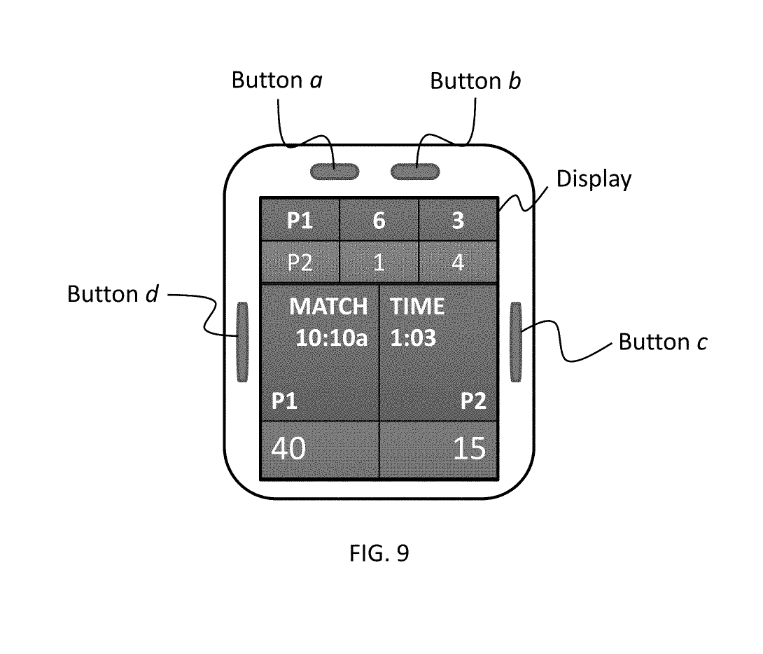

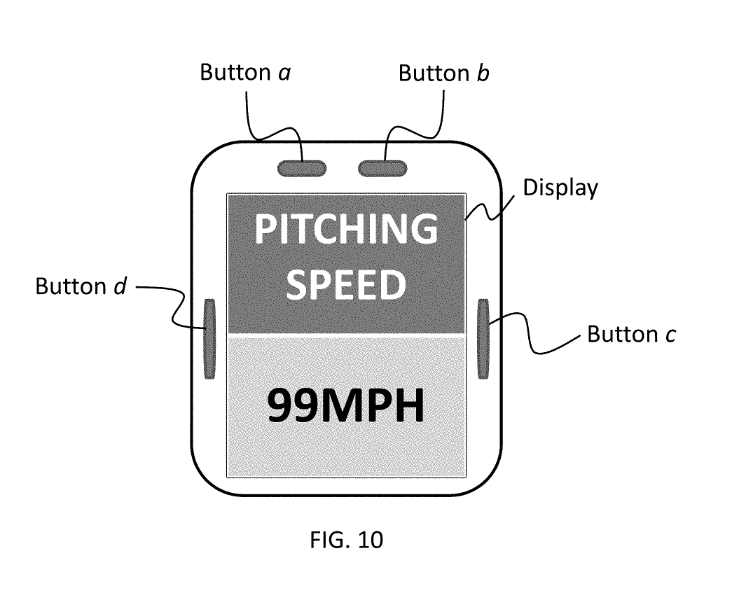

FIG. 8 illustrates a smart wristband device of an embodiment of the present disclosure. The smart wristband device has a display and buttons a, b, c, and d. These buttons may have various functions including a button for updating a score for a home team/player, a button for updating the score for a visitor team/player, a button for undoing the update of the scores, and a button for a mode change (e.g., pressing the mode change button changes the display format between various sports. Additionally, a button may be programmed to load all of the sports chosen by user from a smartphone application into the smart wristband device, and a custom layout may appear on the wristband screen. FIG. 9 illustrates scores of a game displayed on an exemplary embodiment of the wristband device of the present disclosure, and FIG. 10 illustrates a specific aspect of a sport (e.g. pitching speed) selected or customized by the user/player displayed on an exemplary embodiment of the wristband device of the present disclosure.

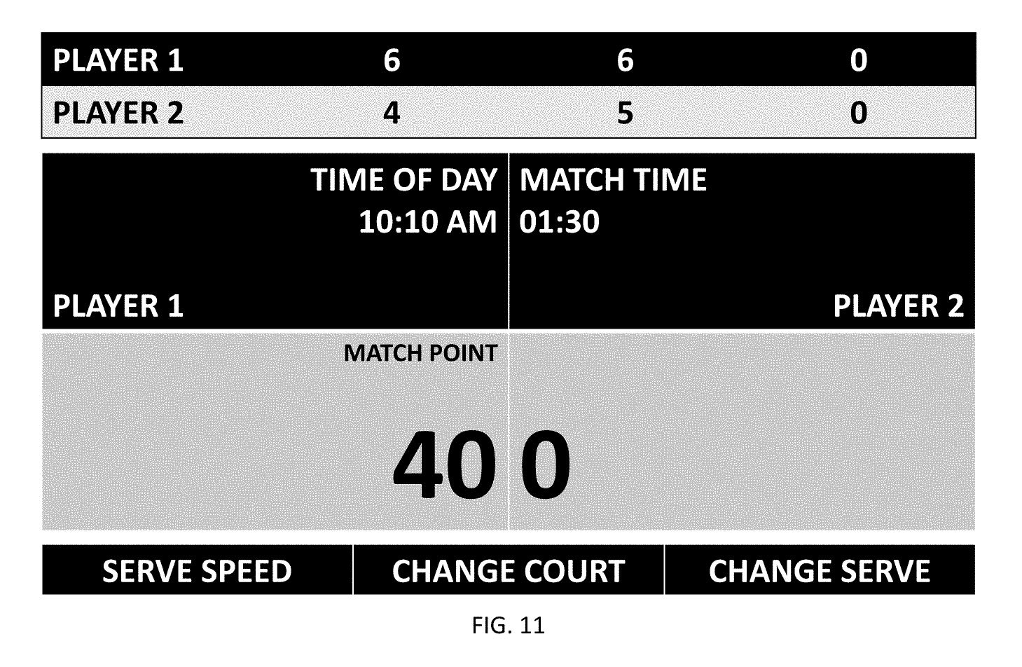

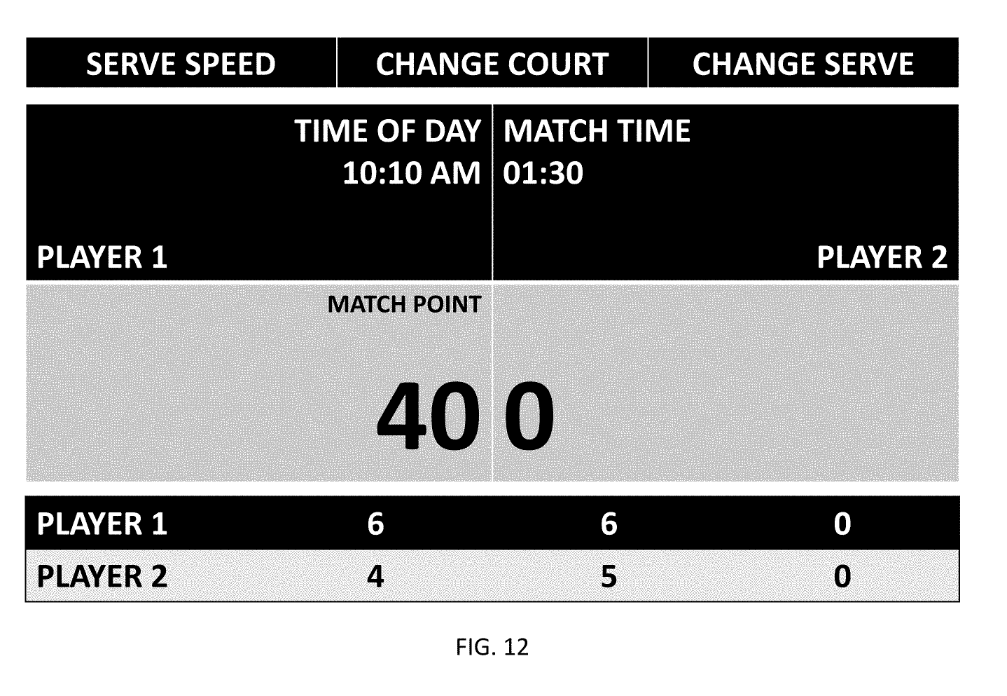

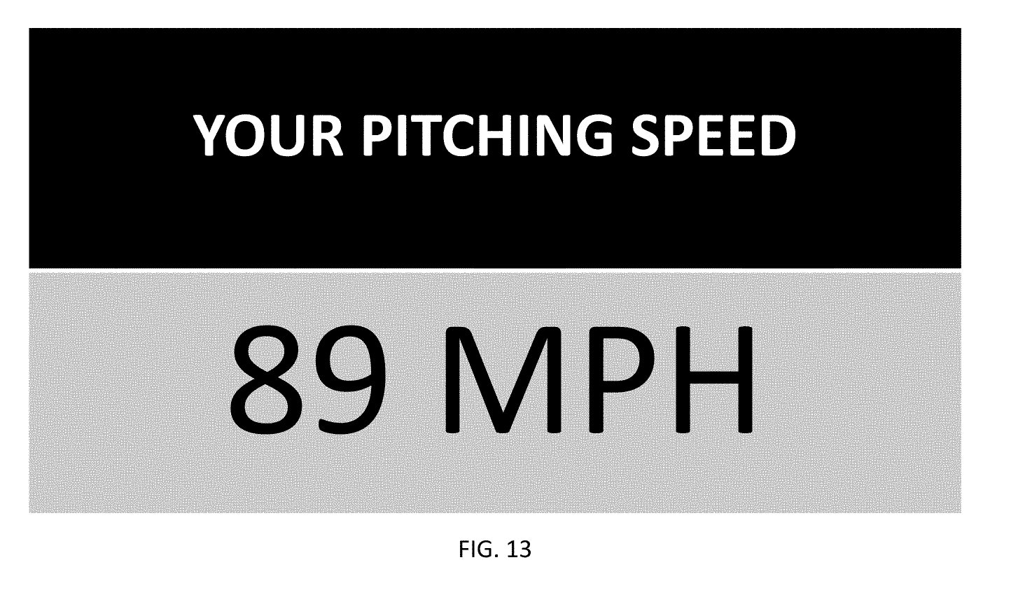

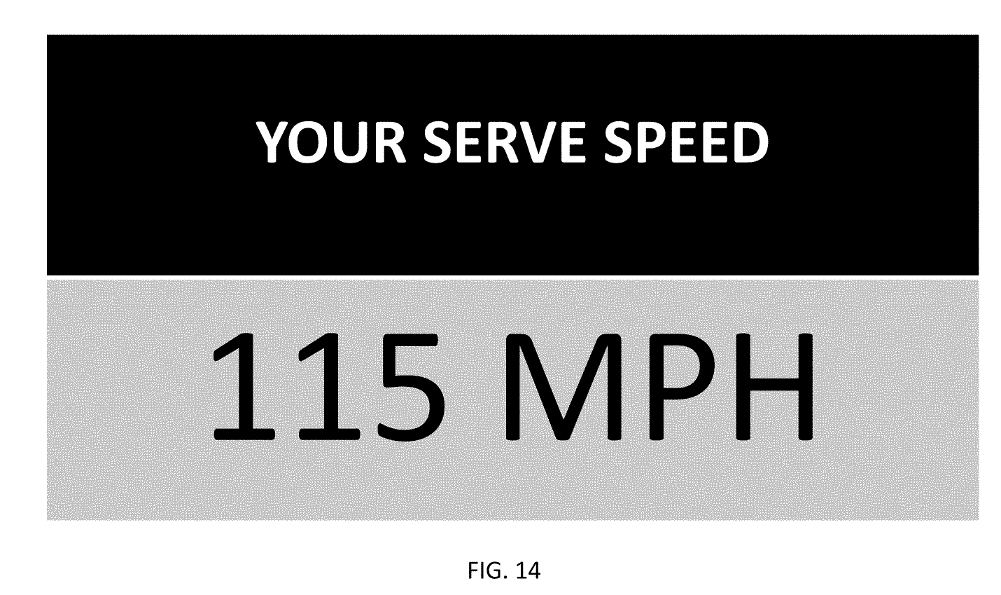

For programming the portable scoreboard device's display regions 110 and 120, the user may choose a preset scoreboard within a mobile application or customize his/her own scoreboard layout to be displayed on the screen. Scoreboard options may include basketball, baseball, tennis, hockey, volleyball and more. If a sport is not available, the user may design a personalized scoreboard and layout within a mobile application using a list of features. For example, if a user chooses a “preset” scoreboard for tennis within a mobile application, the scoreboard shown in FIG. 11 may appear on the scoreboard device's display region 110 or 120. Each of the scoreboard device's display regions 110 and 120 would accordingly display a “tennis” score format as the chosen sport format selected in the mobile application. The user may also choose to customize this layout in the smartphone application. The customized layout may be re-arranged as shown in FIG. 12. In this way, if the user/player of the scoreboard/wristband device wants to use the scoreboard during baseball practice, for example, he/she may customize the scoreboard screen to show only pitching speed (FIG. 13), which would be useful in monitoring progress for that specific metric. Also, the user could change the display format to display other words or messages, such as “Your Serve Speed” instead of “Your Pitching Speed” (FIG. 14). While the scoreboard device is mostly used to keep score, the user/player may use the scoreboard device to display whatever is desired from the provided features within a mobile application.

Control of the scores and other features of the scoreboard device of the present disclosure is not limited to any number of players or wristband devices. Also, the scoreboard device may be clearly visible during the day and/or night, and may be mountable or stand-alone. The scoreboard device of the present disclosure in some embodiments may also store and display player performance data, which may include generic statistics such as steps taken, calories burned, heart rate, speed of swings, distance of jumps, running speed, throwing distance, etc. Through one or more applications downloaded on the scoreboard/wristband device of the present disclosure, the user may create a profile, choose the sports he/she plays or desires to play, and add/invite friends, family members, neighbors, social club members, etc. to interact with the user via the one or more applications.

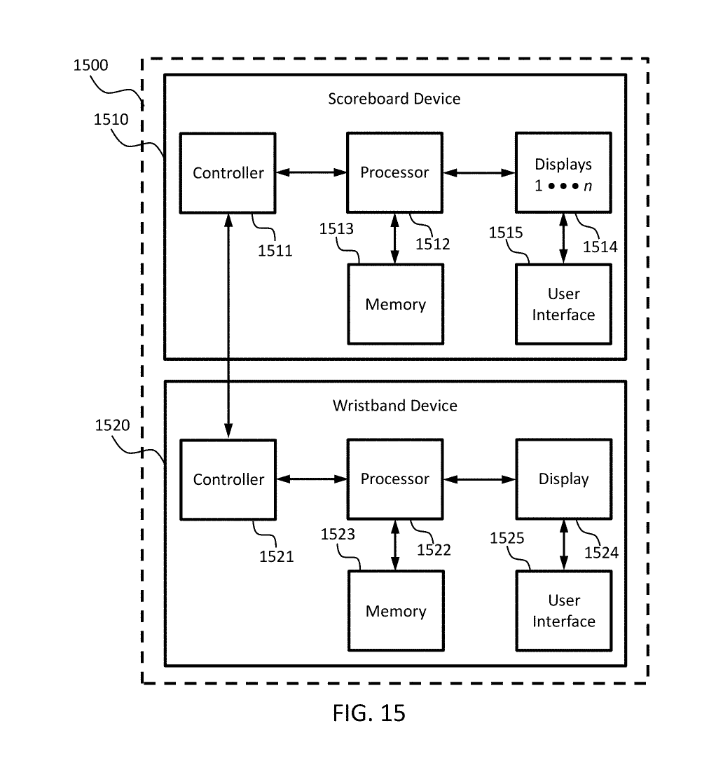

FIG. 15 illustrates a system of one or more exemplary embodiments of the present disclosure, including a scoreboard device and a smart wristband device. In an exemplary embodiment, the system for keeping track of and displaying sports scores comprises a scoreboard device 1510 and a wristband device 1520. The scoreboard device 1510 has a controller 1511 controlling a processor 1512 connected to a memory 1513, wherein the processor 1512 controls displays 1514 1 to n, where n is a natural number. The displays 1 to n may function to provide a user interface 1515 for a touch-sensitive input to manipulate the displayed score and format. The wristband device 1520 has a controller 1521 controlling a processor 1522 connected to a memory 1523, the processor 1522 controls display 1524, which may function to provide a user interface 1525 for a touch-sensitive input to manipulate the displayed score and format. The controller 1511 of the scoreboard device 1510 connects to the controller 1521 of the wristband device 1520 through a cable or wirelessly communicates using any wireless means or methods.

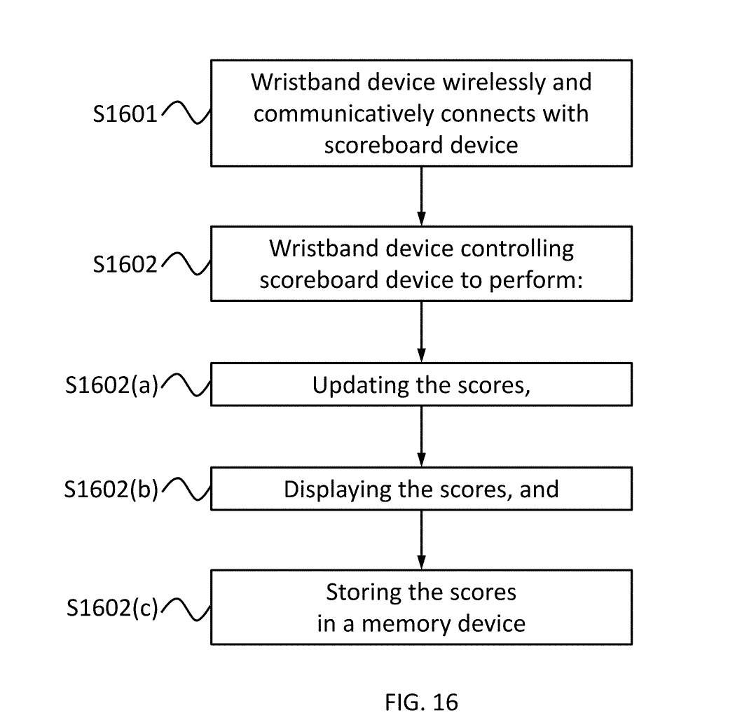

FIG. 16 illustrates a flowchart of a method of one or more exemplary embodiments of the present disclosure. The method for keeping track of and displaying sports scores comprises the following steps: at step S1601, the wristband device wirelessly and communicatively connects with the scoreboard device; at step S1602, the wristband device controls a scoreboard device by through a controller including a processor configured to perform S1602(a), updating the scores, S1602(b), displaying the scores, and S1602(c), storing the scores in a memory device. This method may further comprise the step of comparing the scores and displaying a winner and loser of a game. Additionally, the method may further include the step of determining and displaying nutritional information for the players of a game, and also the step of determining and displaying postings related to trainers and players for practice help based on the scores. The method may also include playing back a video of a scoring moment and then updating a score. The method may also include exporting the scores, which may include any corresponding game and/or player data that can then be viewed and analyzed on other devices.

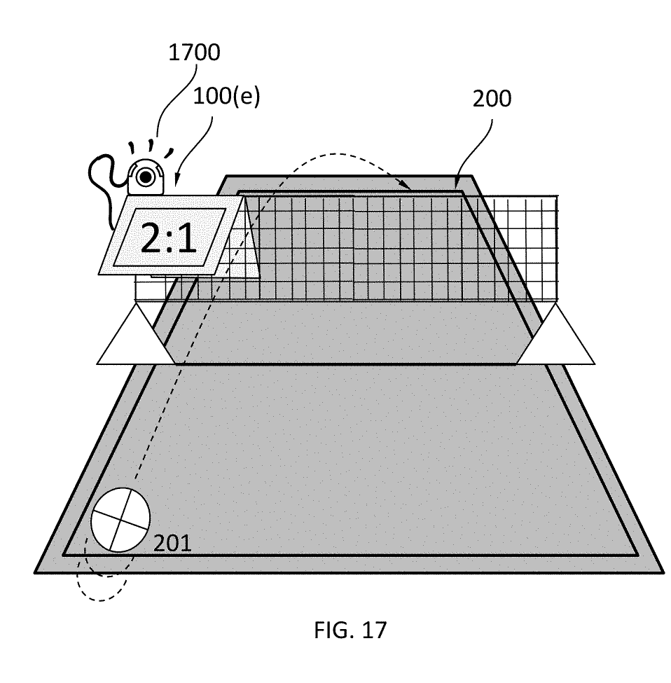

The scoreboard/wristband device may be automatically controlled with a ball sensor/camera and may automatically update scores by itself without any intervention by the players. FIG. 17 illustrates an embodiment of the scoreboard device 100(e) of the present disclosure where the scoreboard device 100(e) may include a camera 1700. The camera 1700 may be in the form of an optical camera, a sensor, or a sensor system that includes a plurality of sensors. The camera 1700 detects and tracks the movement of the ball 201 and detects a ground-touching event or any scoring moment. The camera 1700 can automatically determine an update of a score. The scoreboard/wristband device may enable playback of video recorded concerning a scoring moment for a user/player in order to further judge whether a scoring update is proper. The user/player may change the score if the user/player has a different judgment concerning the automatically updated score, thus enhancing flexibility of the scoring of the game.

The present disclosure contains various advantages. The scorekeeping device may be a wristband or a portable and foldable scoreboard device that may be carried by a user easily. These devices may keep track of scores and automatically perform score calculations. Additionally, displayed sport formats may be freely selected or customized by the user. In some embodiments, a fully automatic mode allows for automatic score updates using a camera to detect the movement of a ball. When the scoreboard device is communicatively connected with a wristband worn by a player, the player may manually change the score, or the score may be automatically updated by the scoreboard device. The camera may allow playback of any recorded video so as to allow the player to judge the score and change it if desired.

While the foregoing has described what is considered to be the best mode and/or other examples, it is understood that various modifications may be made therein and that the subject matter disclosed herein may be implemented in various forms and examples, and that they may be applied in numerous other applications, combinations, and environments, only some of which have been described herein. Those of ordinary skill in the art will recognize that the disclosed aspects may be altered or amended without departing from the true spirit and scope of the subject matter. Therefore, the subject matter is not limited to the specific details, exhibits, and illustrated examples in this description. It is intended to protect any and all modifications and variations that fall within the true scope of the advantageous concepts disclosed herein.

1. A scoreboard device for keeping track of and displaying scores of sports, comprising:
at least one display region including low resolution light emitting diode light emitters of different light colors and
a frame containing the at least one display region,
wherein the scoreboard device is formed of at least one soft material to enable folding of the at least one display region of the scoreboard device without using a joint.

2. The scoreboard device of claim 1, wherein the at least one soft material includes a fabric material.

3. The scoreboard device of claim 1, wherein the scoreboard device is folded to have a book-cover shape and is capable of being hung on a sport net.

4. The scoreboard device of claim 1, wherein the scoreboard device is folded to have opposite outer surfaces displaying scores of a selected or customized sport.

5. The scoreboard device of claim 1, wherein both of the opposite outer surfaces display the same image.

6. The scoreboard device of claim 1, wherein both of the opposite outer surfaces display different images.

7. The scoreboard device of claim 1, the scoreboard device wirelessly and communicatively connects with a wristband device which controls displaying, updating and storing the scores of one of the sports freely selected or customized by a user.

8. The scoreboard device of claim 1, further comprising:
a voice controlling device for voice-controlling the scoreboard device or
button devices for button-controlling the scoreboard device to control displaying, updating and storing the scores of one of the sports freely selected or customized by a user.

9. The scoreboard device of claim 1, further comprising a camera mounted on or wirelessly and communicatively connected with the scoreboard device to detect and track a movement of a ball so as to update the scores or performance parameters such as ball speed of one of the sports freely selected or customized by a user.

10. The scoreboard device of claim 1, wherein the low resolution light emitting diode light emitters are surface-mounted and arranged in a matrix.

11. The scoreboard device of claim 10, wherein the low resolution light emitting diode light emitters have a uniform density of 36 light emitting diodes per square inch.

12. A wristband device for keeping track of and displaying scores of sports, comprising a controller that includes a processor configured to perform:
updating the scores,
displaying the scores, and
storing the scores in a memory device.

13. The wristband device of claim 12, wherein the processor is configured to further perform:
voice- or button-controlling by a user to control the updating, displaying and storing the scores.

14. The wristband device of claim 12, further comprising a camera mounted on or wirelessly and communicatively connected with the wristband device to detect and track a movement of a ball of a sport.

15. The wristband device of claim 12, the processor further capable of installing applications downloaded from a network, the applications configured to perform one or more of calculate the scores, export the scores, calculate nutrition related to the scores, provide shopping information, and provide postings of players for practicing to enhance athletic performance.

16. A system for keeping track of and displaying scores of sports, comprising:
a scoreboard device having
at least one display region including low resolution light emitting diode light emitters of different light colors and
a frame containing the at least one display,
wherein the scoreboard device is formed of at least one soft material to enable folding of the at least one display region of the scoreboard device without using a joint; and
a wristband device having a controller that includes a processor configured to perform updating the scores, displaying the scores, and storing the scores in a memory device,
wherein the wristband device wirelessly and communicatively connects with the scoreboard device.

17. The system of claim 16, wherein the low resolution light emitting diode light emitters are surface-mounted and arranged in a matrix.

18. The scoreboard device of claim 17, wherein the low resolution light emitting diode light emitters have a uniform density of 36 light emitting diodes per square inch.

19. A method for keeping track of and displaying scores of sports, comprising:
controlling a scoreboard device by a wristband device having a controller including a processor configured to perform:
wirelessly and communicatively connecting with the scoreboard device,
updating the scores,
displaying the scores, and
storing the scores in a memory device.

20. The method of claim 19, further comprising:
achieving the scores and
displaying a winner and a loser of a game.

21. The method of claim 20, further comprising:
determining and displaying nutrition information for the winner and the loser of the game, and
determining and displaying postings related to trainers and players for practice based on the scores.

22. The method of claim 19, further comprising:
playing back a video about a scoring moment and
changing the updated scores.
